(19) United States
(12) Patent Application Publication
(10) Pub. No.: US 2016/0128168 A1
(43) Pub. Date: May 5, 2016

(54) NETWORK LIGHT DEVICE FOR A TRANSPORT UNIT

(71) Applicant: THERMO KING CORPORATION, Minneapolis, MN (US)

(72) Inventors: Timothy A. Walker, Plymouth, MN (US); Russell L. Sanders, Minnetonka, MN (US)

(21) Appl. No.: 14/932,227

(22) Filed: Nov. 4, 2015

Related U.S. Application Data
(60) Provisional application No. 62/074,836, filed on Nov. 4, 2014.

(51) Int. Cl. H05B 37/02; B60Q 3/06; H05B 33/08

(52) U.S. Cl. CPC H05B 37/0272; H05B 37/0227; H05B 33/0872; B60Q 3/06

(57) ABSTRACT

Wirelessly networked network light device(s) and method for operating and/or controlling the network light device(s). The network light device can be connected to a network, and be controlled by a controller connected to one or more sensors. The operation of the network light device, such as a color of the light emitted, etc., can be controlled by the controller based on conditions detected by the one or more sensors.

### FIELD

The embodiments disclosed herein relate generally to devices and systems directed to networked light providing devices and methods for operating and/or controlling the networked light providing devices.

### BACKGROUND

Transport refrigeration systems are used to cool a container (typically referred to as a refrigerated transport unit), trailer, railcar or other transport unit (“TU”). The TU is commonly used to transport perishable items such as produce and meat products. In such a case, a transport refrigeration system (“TRS”) can be used to condition the air inside a cargo space of the TU, thereby maintaining desired temperature and humidity during transportation or storage. Different perishable items can require different desired temperatures during transport. A transport refrigeration unit (“TRU”) is attached to the TU to facilitate a heat exchange between the air inside the cargo space and the air outside of the TU, and the TU can have multiple zones (e.g., portions, volumes, etc.), wherein the multiple zones of the TU can have different set temperatures for transporting the different perishable items. That is, each zone of the TU can have different set (e.g., desired) temperatures so that each zone can contain perishable items that might require such set temperature. Such TU can be called a multi-zone TU or a multi-zone trailer. For example, a multi-zone TU having only two zones can be called a dual zone TU (or dual zone trailer).

### SUMMARY

Embodiments disclosed herein are directed to controlling networked light providing devices based on various sensor inputs using a network, for example, for transport refrigeration. Wirelessly connected networked light providing device(s) and method for operating and/or controlling the networked light providing device(s) are disclosed. The operation of the networked light providing device, such as a color of the light emitted, wavelength of the light emitted, intensity of the light emitted, etc., can be controlled by a controller based on conditions detected by one or more sensors.

### BRIEF DESCRIPTION OF THE DRAWINGS

Referring to the drawings in which like reference numbers represent corresponding parts throughout.

FIG. 1 is a schematic diagram of a TU with a network system including network light devices according to an embodiment.

FIG. 2 is a schematic diagram of a network system according to an embodiment.

FIG. 3 is a schematic diagram of a network system according to another embodiment.

FIG. 4 is a flowchart of a method for operating a network light device according to an embodiment.

FIG. 5 is a flowchart of a method for operating a network light device according to an embodiment.

FIG. 6 is a flowchart of a method for operating a network light device according to an embodiment.

### DETAILED DESCRIPTION

Embodiments disclosed herein are directed to controlling light based on various sensor inputs using a network, for example, for transport refrigeration.

References are made to the accompanying drawings that form a part hereof, and in which is shown by way of illustration of the embodiments in which the methods and systems described herein may be practiced.

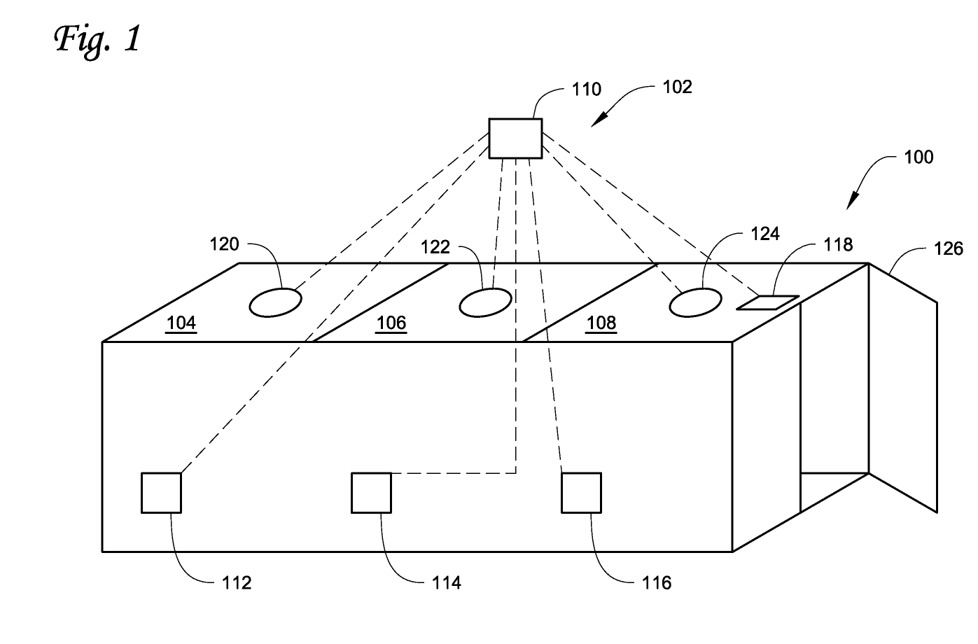

FIG. 1 shows a schematic diagram of a TU 100 that includes a network system 102. Examples of the TU 100 include, but are not limited to, a container on a flat car, an intermodal container, a truck, a boxcar, or other similar transport unit (generally referred to as a “climate controlled transport unit”). A refrigerated transport unit is commonly used to transport perishable items such as, but not limited to, produce, frozen foods, and meat products. Generally, the refrigerated transport unit includes a transport refrigeration unit (TRU) that is attached to a transport unit to control the environmental condition of an interior space within the TU. The term “transport refrigeration system” refers to a refrigeration system for controlling an environmental condition such as, but not limited to, temperature and/or humidity of an internal space of the TU 100. The TU 100 can be configured to have one or more zones. FIG. 1 shows the TU 100 as a three-zoned container, having three zones 104, 106, 108. One or more of the zones 104, 106, 108 can have a predetermined setting for the zone's environmental condition(s) (e.g., temperature range, humidity range, ultraviolet light requirement, etc.). That is, each of the zones 104, 106, 108 can have a requirement for cargo intended to be contained in that zone 104, 106, 108. These requirements can be different from zone to zone. These requirements can be the same and/or similar (e.g., two zones having overlapping ranges).

The network system 102 includes one or more devices (e.g., a controller 110, one or more sensors 112, 114, 116, 118, and/or one or more network light devices 120, 122, 124) that are in communication via wired and/or via wireless connection. In an embodiment, the network system 102 includes at least one device that is a wireless device. In other embodiments, the network system 102 can include only wireless devices. Accordingly, one or more (e.g., all) of the devices (e.g., 110, 112, 114, 116, 118, 120, 122, 124) can be a wireless device(s). The term “wireless device” refers to a communication device that is configured to transmit and/or receive data via a non-wired connection over a distance, such as, for example, between different locations of the TU 100. The network system 102 of wireless devices can be connected via, for example, a mesh network, a star network, a radio frequency for consumer electronic (RF4CE) network (e.g., ZigBee®), WiFi, Bluetooth, etc.

In an embodiment, the network system 102 includes the controller 110, one or more sensors 112, 114, 116, 118, and/or one or more network light devices 120, 122, 124, wherein the sensors 112, 114, 116, 118 and the network light devices 120, 122, 124 are in communication with the controller 110. In another embodiment, the controller 110, one or more sensors 112, 114, 116, 118, and one or more network light devices 120, 122, 124 are in communication with each other. It is also possible that the network system 102 can include more than one controller 110.

The controller 110 (or controller device, coordinator, etc.) refers to an electronic device, which can include a processor and a non-transitory computer-readable medium (e.g., memory, computer-readable storage, etc.), configured to communicate with another device to receive data, manage, command, direct and/or regulate the behavior of the another device (e.g., one or more sensors 112, 114, 116, 118, and/or one or more network light devices 120, 122, 124).

The sensors 112, 114, 116 can be environmental condition sensors (e.g., temperature and/or humidity sensors). The temperature sensor detects a temperature. The humidity sensor detects humidity (e.g., relative humidity). The sensors 112, 114, 116 are configured to detect one or more environmental condition(s) and communicate that information to the controller 100. The sensor 118 can be a door sensor configured to detect an open and/or closed state of a door 126 (or doors) of the TU 100. The sensor 118 is configured to send data to the controller 110 regarding the state and/or change in the state of the door 126. For example, when the state of the door 126 changes from the open state to the closed state, or from the closed state to the open state, the sensor 118 can send the door state data or the change in the door state data to the controller 110. When the TU 100 includes multiple doors (e.g., rear doors, side doors, etc.) the network system 102 can include multiple door sensors for each of the doors of the TU 100. Each of the sensors 112, 114, 116 can be a door sensor (e.g., for a TU 100 with multiple side doors, for example, for each of the zones 104, 106, 108), a temperature sensor, a humidity sensor, a light sensor, etc., or any combinations thereof. The sensors 112, 114, 116, 118 can be a sensor which can detect multiple conditions (a combination of door state, temperature, humidity, light, etc.).

The term “networked light providing device” is used synonymously herein with “networked light,” “networked light device,” and/or “network light device.” Each of the network light devices 120, 122, 124 is a device configured to connect to a network of the network system 102 and emit light based on, for example, receive data from another device that is connected to the network. Each of the network light devices 120, 122, 124 includes a light emitting component, a power source, and a network interface. Each of the network light devices 120, 122, 124 can also include a processor configured to transform received control data for operation of the light emitting component. Each of the network light devices 120, 122, 124 can also include a non-transitory computer-readable medium, which can store, for example, network identification data for connecting to the network. Each of the network light devices 120, 122, 124 can be connected to a wireless network, such as for example, a mesh network, a star network, a radio frequency for consumer electronic (RF4CE) network (e.g., ZigBee®), WiFi, Bluetooth, etc. Each of the network light devices 120, 122, 124 can be controlled by the controller 110. The controller 110 can be, connected to (e.g., by wire and/or wirelessly in the same network) one or more sensors 112, 114, 116, 118. The controller 110 can control the operation of the network light devices 120, 122, 124, such as a color of the light emitted, wavelength of the light emitted, intensity of the light emitted, blinking of the light, etc., based on a condition detected by one or more of the sensors 112, 114, 116, 118.

The network system 102 of the TU 100 can include any number and type of sensors. The network system 102 can include any number of network light devices. The network system 102 can also include other devices, such as a display device, which can be a wired and/or wireless device, connected to the network (e.g., in communication with the controller 110).

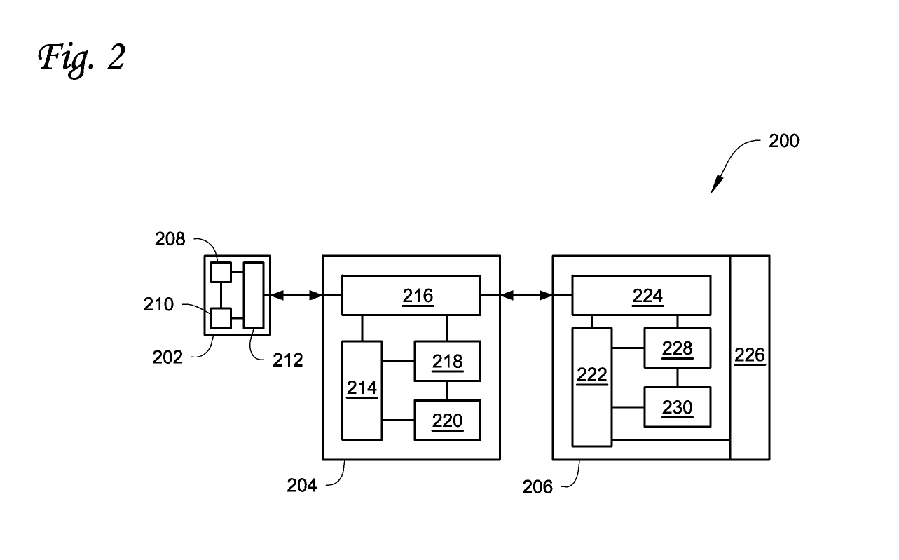

FIG. 2 is a schematic diagram of a network system 200 according to another embodiment. The network system 200 includes a sensor 202, a controller 204, and a network light device 206.

The sensor 202 can include a power source 208 that powers a detector 210 and a network interface 212. The sensor 202 can be a door sensor, a temperature sensor, a humidity sensor, a sensor that can detect multiple conditions (e.g., a combination of door state, temperature, and/or humidity, etc.), wherein the detector 210 is configured to detect one or more of these conditions (e.g., door state, temperature, humidity, a combination of door state, temperature, and/or humidity, etc.). The sensor 202 is in communication (wired and/or wirelessly) with the controller 204 via the network interface 212. The network interface 212 is configured to transmit (e.g., wirelessly) data (e.g., condition data) from the detector 210 for reception by another device, such as for example the controller 204. Examples of condition data include, but are not limited to, temperature data, humidity data, door state data, operating condition of the sensor data, etc., and/or combinations thereof).

The controller 204 includes a power source 214 that powers a network interface (e.g., a wireless network interface) 216, a processor 218, and a non-transitory computer-readable medium 220. The network interface 216 is configured to communicate with other devices (e.g., the sensor 202, the network light device 206, etc.). For example, the network interface 216 is configured to receive condition data from the sensor 202 and transmit the condition data to the processor 218 and/or the non-transitory computer-readable medium 220. The processor 218 is configured to execute a set of computer-executable instructions, for example, for performing any and/or all of the methods and/or processes described herein. The computer-executable instructions can also process the condition data received. The processor 218 is also configured to send control data for receipt by one or more other devices (e.g., the sensor 202 and/or the network light device 206, etc.) via the network interface 216. The processor 218 can be configured to save the condition data and/or other data derived from the condition data according to the set of computer-executable instructions to the non-transitory computer-readable medium 220. The non-transitory computer-readable medium 220 can also store the computer-executable instructions, for example, for performing any and/or all of the methods and/or processes described herein.

The network light device 206 includes a power source 222 that powers a network interface (e.g., a wireless network interface) 224 and a light emitting component 226. The network light device 206 can receive control data from the controller 204 and the light emitting component 226 can be powered on or off according to the control data received. Examples of the light emitting component 226 include a light bulb, a light emitting diode (LED), etc. Embodiments of the light emitting component 226 can flash and/or flicker based on the control signal received. An embodiment of the light emitting component 226 can emit visible light. An embodiment of the light emitting component 226 can also emit different intensities of light.

An embodiment of the light emitting component 226 can emit a wide range of different colors and/or wavelengths of light. For example, an embodiment of the light emitting component 226 includes a LED which can emit visible light in the wavelength ranges for one or more of yellow, green, blue, red, orange, purple, etc. Accordingly, the light emitting component 226 can emit a particular color based on the control signal received. The controller 204 can determine which color the network light device 206 should emit and send the appropriate data to the network light device 206.

Another embodiment of the light emitting component 226 can emit ultraviolet light. For example, the light emitting component 226 can emit ultraviolet light when the sensor 202 detects that the door to a container is closed (e.g., alternatively, the sensor 202 detects that one or more doors are closed or that all of the doors are closed), and sends the “door is closed” condition data to the controller 204. The controller 204 can then send a control data to the network light device 206 to turn on ultraviolet light (because, for example, the cargo inside the container might require the ultraviolet light). The network light device 206 can receive the control data and the light emitting component 226 can be powered on to emit ultraviolet light.

Another embodiment of the light emitting component 226 includes a self-diagnosis component that can send a diagnosis signal (or signals) for receipt by the controller 204. The diagnosis signal can indicate the operational status of the light emitting component 226. Examples of the operational status can include, but are not limited to, the light emitting component 226 is not operational (e.g., broken).

In an embodiment, the network light device 206 can also include a processor 228 configured to transform received control data for operation of the light emitting component 226.

In another embodiment, the network light device 206 can also include a non-transitory computer-readable medium 230 for storing thereon control data received, network configuration information (e.g., identification data), computer-executable instructions for being executed by the processor 228, and/or other data.

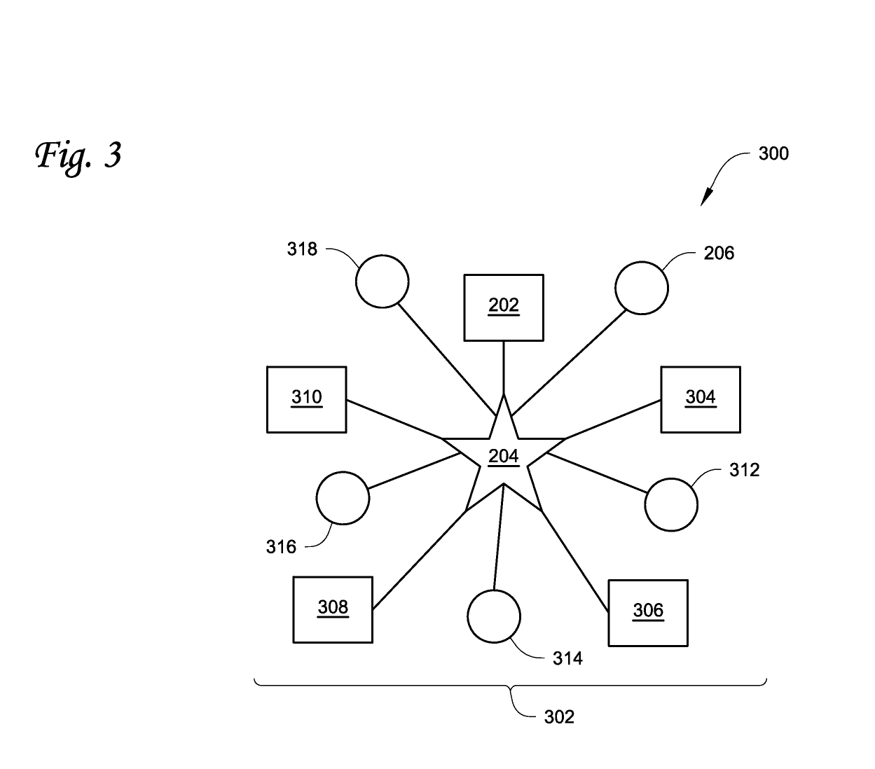

FIG. 3 is a schematic diagram of a network system 300 according to an embodiment. The network system 300 is configured according to a Star network topology 302. The sensor 202, the controller 204, and the network light device 206 (also shown in FIG. 2) can be a part of the Star network topology 302. Accordingly, one of the devices connected to the Star network topology 302 can be the controller 204, which is configured to be the “central hub” of the Star network topology 302 for the network system 300. Other devices are connected to (e.g., communicate with and/or through) the controller 204. The other devices are “leaf nodes” and can include other sensors 304, 306, 308, 310 and other network light devices 312, 314, 316, 318. The Star network topology 302 allows the controller 204 to control all communication among and between the other devices 202, 206, 304, 306, 308, 310, 312, 314, 316, 318. Accordingly, the controller 204 can operate and/or control one or more network light devices 206, 312, 314, 316, 318 based on the one or more condition data received by the controller 204 from the one or more of the sensors 202, 304, 306, 308, 310.

For example, the controller 204 can receive condition data from sensor 202 and 304 and based on the received condition data, the controller 204 can send control data to the network light devices 312, 314 to turn on to emit yellow light, and send control data to the network light device 316 to increase the intensity (luminosity), and send control data to the network light device 318 to turn off and stop emitting ultraviolet light. Other combinations of control are possible by providing the appropriate computer-executable instructions to the processor of the controller 204 and/or by user input to the controller 204.

For example, during transport or trip of a TU that includes the network system 300, one or more of the sensors 202, 304, 306, 308, 310 can transmit various condition data to the controller 204. One or more sensors 202, 304, 306, 308, 310 can be positioned in any of one or more zones of the TU. The controller 204 can store the condition data to the non-transitory computer-readable medium, process the various condition data, and/or store various determinations made based on the received condition data. An example of such determination can be that in one of the zones of the TU, the temperature of the zone exceeded a predetermined temperature range that is appropriate for the cargo stored in that zone. At the end of the trip, when an operator opens a door of the TU, a door sensor (e.g., 202) can send the door condition state of being “open” to the controller 204, which can then send control data to the network light device (e.g., 206) that is in the one of the zones to, for example, blink and/or emit a red light or perform one or a combination of light emitting processes to communicate visually to the operator that something happened in the zone in the TU during the trip that might have affected the cargo in that zone. Thus, when the operator opens the door to the TU and sees a flashing light in a zone, the operator can quickly understand that, for example, the environmental condition in that zone may have exceeded the predetermined range during transport. This can indicate that the cargo in that zone might have experienced an environmental condition outside the predetermined range.

Further, for example, at any time before and/or after a trip of the TU, an operator can decide to run a diagnostic of the network system 300. Before the TU is dispatched (e.g., on a trip lasting days), a system check for making sure all devices/components are operational might be desirable. For example, prior to starting a trip and/or loading of cargo, it might be desirable for the operator to understand whether the TU and each of the zones are ready and/or set, and/or whether each of the components in the network system 300 is operational. For example, after the end of the trip, it might be desirable for the operator to understand whether the environmental conditions of each zone of the TU are as they should be, and/or whether each of the components in the network system 300 is operational. To achieve this, for example, the controller 204 can transmit (e.g., send) an instruction (e.g., control data) to each of the devices 202, 206, 304, 306, 308, 310, 312, 314, 316, 318 to transmit back to the controller 204 an operational state information as data or a signal. In another example, the controller 204 can see whether it is receiving condition data from each of the sensors 202, 304, 306, 308, 310 and/or transmit control data to each of the network light devices 206, 312, 314, 316, 318 to operate the network light devices 206, 312, 314, 316, 318 (e.g., power on the network light devices 206, 312, 314, 316, 318 to emit light, blink the lights, emit a particular color, etc.). The operator can visually check to see whether the network light devices 206, 312, 314, 316, 318 operate as they should be if they are indeed operational. Further, if the controller 204 does not detect (e.g., fails to receive condition data) from any of the sensors 202, 304, 306, 308, 310, then the controller 204 can transmit a control data to a particular network light device(s) (e.g., one or more of 206, 312, 314, 316, 318) that is in the same zone as the failed sensor to operate the emission of light, so that the operator can be notified visually that the sensor in that zone is not fully operational with the network system 300. For example, the failed sensor indication can be a blinking light emitting from one of the network light devices, and/or emitting a red color, etc. Thus, in a diagnostic mode, the network system 300 (e.g., the controller 204) is configured to communicate visually to show problem areas, e.g., zones, in a TU. Problem areas can include, for example, temperature and/or humidity detected in a zone is not what it is set to be. Further, if everything is fully operational in the network system 300, the controller 204 can indicate this fully operational condition visually as well, for example but not limited to, by emitting bright white light from all network light devices 206, 312, 314, 316, 318.

In yet another embodiment, the network system 300 in a multi-zone TU can provide guidance for loading of cargo so that error can be reduced. For example, the controller 204 can send control data to network light devices in each of the zones of the multi-zone TU, and according to particular environment condition that is predetermined for each of the zones, the network light device in each of the zones can be operated to emit a particular light in the visible spectrum. Further, each of the cargos that are predetermined to have a particular environmental condition during transport can be tagged with a sign, mark, tape, or other designators that match the color of the light in the particular zone of the TU. That is, in the TU, the color of the light emitted by the network light device in that zone can be associated with a predetermined temperature, temperature range, temperature setting, and/or other conditions. Further, that same color can be used to tag the cargo, so that the operator who loads the cargo to the multi-zone TU can easily and quickly identify which cargo should be loaded to which zone of the TU. For example, a zone with yellow light can be for cargo with yellow tags, a zone with red light is for cargo with red tags, etc. The colors can be used to match the required temperature and/or humidity of the cargo to the set temperature and/or humidity of the zone in the TU.

In an embodiment, the devices 202, 204, 206, 304, 306, 308, 310, 312, 314, 316, 318 are in a mesh network and all of the devices 202, 204, 206, 304, 306, 308, 310, 312, 314, 316, 318 can (when in range) communicate with each other. For example, when the sensor 202 is a door sensor and the sensor 202 detects that a door associated with the sensor 202 has been closed, the sensor 202 can transmit a condition data that is received by the network light device 206 (and/or any of the other network light devices or groups of the network light devices) and the network light device 206 can be powered on to emit ultraviolet light.

In an embodiment, the network system 300 can include one or more router devices and/or repeater devices to help one or more wireless devices (e.g., one or more of the devices 202, 206, 304, 306, 308, 310, 312, 314, 316, 318 that are configured to communicate wirelessly) communicate with the controller 204 and/or each other.

In an embodiment, the network system 300 can include a display device in communication with the controller 204. For example, a remote display panel located at the back of the TU, e.g., by the rear door, can be configured to display conditions of one or more of the devices 202, 204, 206, 304, 306, 308, 310, 312, 314, 316, 318 and/or the zones of the TU as determined by the controller 204 based on the condition data received from the sensors 202, 304, 306, 308, 310.

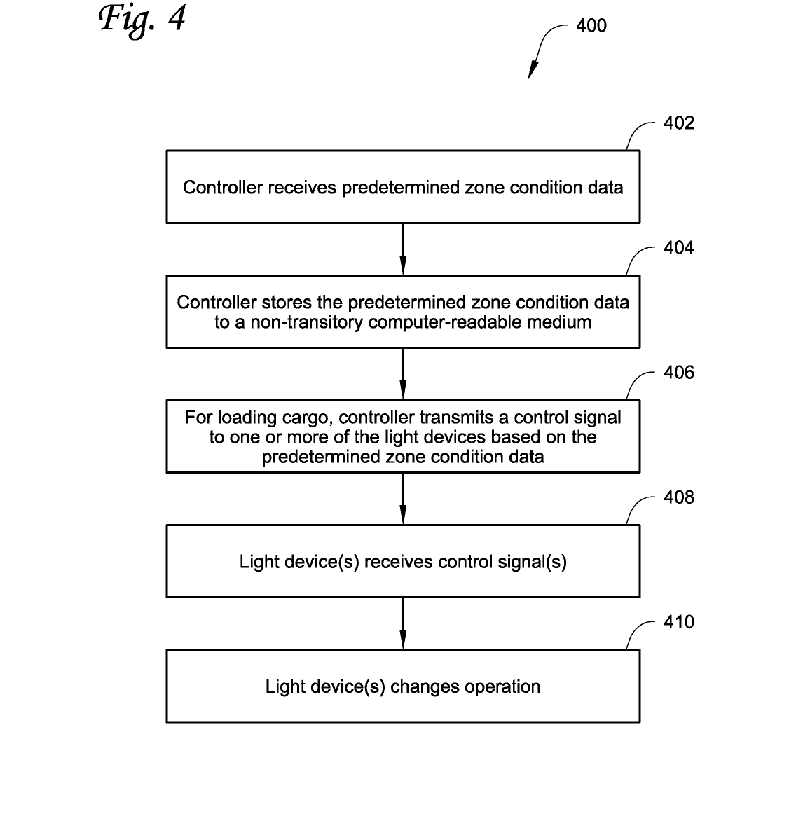

FIG. 4 is a flowchart of a method 400 for operating a network light device (e.g., 104, 106, 108, 206, 312, 314, 316, 318 shown in FIGS. 1-3) according to an embodiment. The method 400 includes the controller receiving 402 (e.g., being provided with) a predetermined condition parameter(s) (e.g., a set point and/or a range of values representing acceptable condition data, etc.). This predetermined condition parameter(s) can be, for example, a desired setting of the environmental conditions that a particular zone (or zones) of a TU for a particular cargo that is to be transported in that zone (or zones) of the TU. Then the controller stores 404 the predetermined condition parameter(s) to a non-transitory computer-readable medium (e.g., the non-transitory computer-readable medium 220 shown in FIG. 2). When cargo is to be loaded into the TU, the controller transmits 406 a control signal (e.g., control data) to one or more of the network light devices in the network based on the predetermined condition parameter(s). The network light device receives 408 the control signal. Then the network light device changes 410 its operation, such as for example, being powered on to emit light, changing the wavelength of the light being emitted, being powered off, flashing the light on and off, etc.

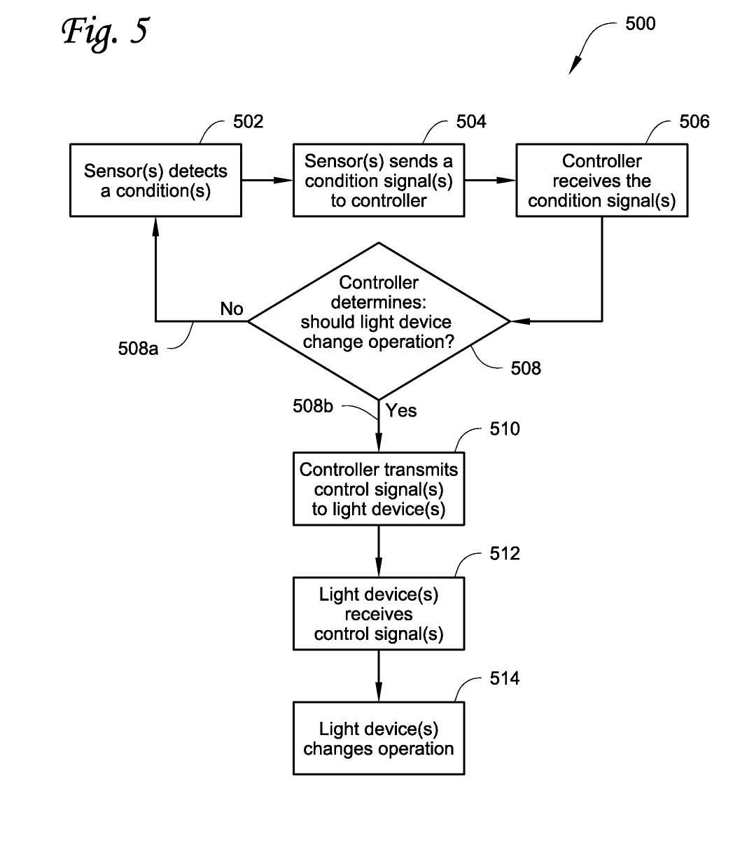

FIG. 5 is a flowchart of a method 500 for operating a network light device (e.g., 104, 106, 108, 206, 312, 314, 316, 318 shown in FIGS. 1-3) according to an embodiment. The method 500 includes a sensor detecting 502 a condition, such as for example, a sensor detecting (or measuring) a temperature, a humidity level, relative humidity, light, darkness, door being open, door being closed, etc. Then the sensor sends 504 (e.g., transmits for being received by another device such as a controller) a data of the detected condition as condition data to the controller. The controller receives 506 the condition data. Then, the controller determines 508 whether one or more of the network light devices in the network should change its (their) operation. When the controller determines 508a that the one or more of the network light devices should not change its (their) operation, then the method 500 can return to step 502. When the controller determines 508b that the one or more of the network light devices should change its (their) operation, then the controller transmits 510 a control data (e.g., signal(s)) for being received by the one or more of the network light devices. For example, the control data can include identifying information about which of the one or more of the network light devices the control data is destined for. The one or more of the network light devices receives 512 the control data. Then the one or more of the network light devices changes 514 its (their) operation, such as for example, being powered on to emit light, changing the wavelength of the light being emitted, being powered off, flashing the light on and off, etc.

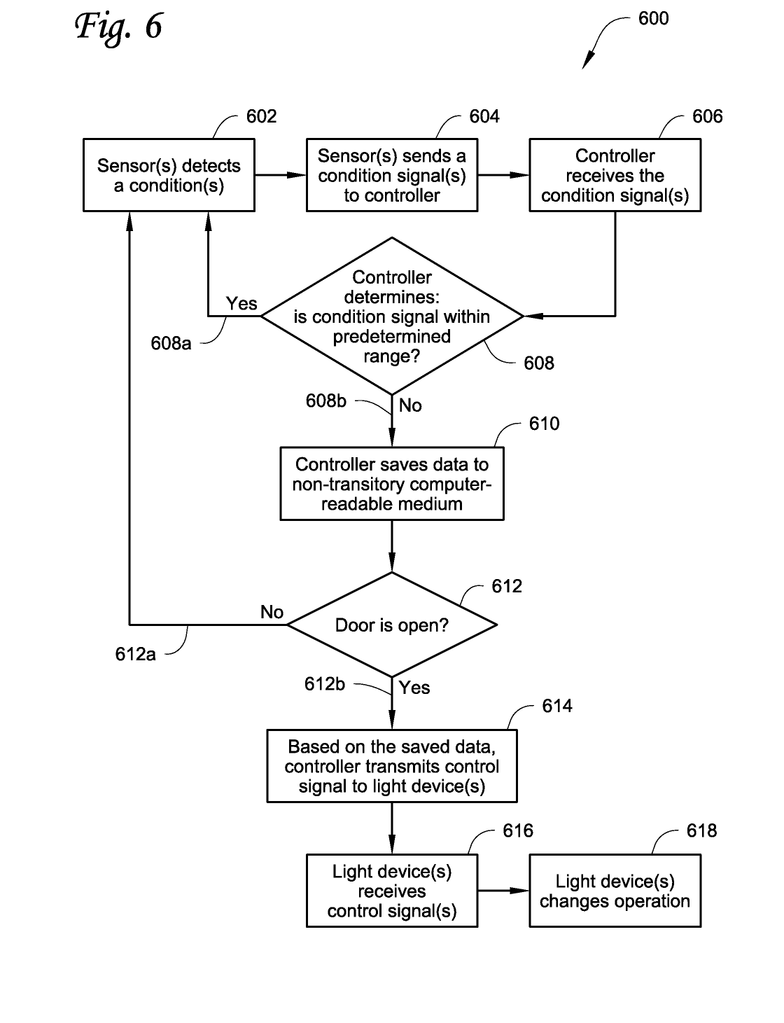

FIG. 6 is a flowchart of a method 600 for operating a network light device (e.g., 104, 106, 108, 206, 312, 314, 316, 318 shown in FIGS. 1-3) for a TU according to an embodiment. The method 600 includes a sensor detecting 602 a condition, such as for example, a sensor detecting (or measuring) a temperature, a humidity level, relative humidity, light, darkness, door being open, door being closed, etc. Then the sensor sends 604 (e.g., transmits for being received by another device such as a controller) a data of the detected condition as condition data to the controller. The controller receives 606 the condition data. Then, the controller determines 608 whether the condition data received is meets (e.g., satisfies, or within a range, etc.) a predetermined parameter (e.g., stored in a non-transitory computer-readable medium of the controller) associated with the sensor that sent the condition data. When the controller determines 608a that the condition data meets the predetermined parameter, the method 600 can return to step 602. When the controller determines 608b that the condition data does not meet (e.g., fails to meet, fails to satisfy, is outside a range, etc.) the predetermined parameter, the controller saves 610 that condition data and/or the determination that the condition data did not meet the predetermined parameter to a non-transitory computer-readable medium (such as, for example, the non-transitory computer-readable medium of the controller and/or other device in the network). The controller can also save other data (e.g., length of time the condition data failed to meet the predetermined parameter, location information, etc.) to the non-transitory computer-readable medium.

The controller determines 612 whether a door of the TU is open or not (e.g., by a door sensor that detects whether one (or more) of the doors of the TU is open and transmits that condition data (e.g., door open status) to the controller). When the controller determines 612a that the door is not open, then the method 600 can return to step 602. When the controller determines 612b that the door is open, then the controller can transmit 614 control data (e.g., signal(s)) to one or more of network light devices in the network based on the data saved in the non-transitory computer-readable medium. In an embodiment, the controller can determine that the one or more of the network light devices should change its (their) operation based on the data saved in the non-transitory computer-readable medium. The one or more of the network light devices receives 616 the control data. Then the one or more of the network light devices changes 618 its (their) operation, such as for example, being powered on to emit light, changing the wavelength of the light being emitted, being powered off, flashing the light on and off, etc.

### Aspects:

It is appreciated that any of Aspects 1-20 can be combined.

Aspect 1. A networked light system for a transportation unit, comprising:

a sensor configured to detect an environmental condition inside the transportation unit and transmit the environmental condition detected as condition data;

a controller in communication with the sensor configured to receive the condition data and transmit control data; and

a network light device configured to receive the control data and emit light based on the control data received.

Aspect 2. A networked light system for a transportation unit, comprising:

one or more network light devices; and

a controller in communication with the one or more network light devices, the controller being configured to transmit control data for being received by the one or more network light devices, the one or more network light devices being configured to receive the control data and emit light based on the control data received.

Aspect 3. A transport unit, comprising the network light system according to any of the aspects 1-2.
Aspect 4. A network light device, comprising:

a network interface configured to receive control data;

a light emitting component configured to emit light based on the control data received via the network interface; and

a power supply configured to supply power to the network interface and the light emitting component.

Aspect 5. The network light device according to any of the aspects 1, 2, and 4, wherein the light emitting component is configured to emit one or more wavelengths of the light.
Aspect 6. The network light device according to any of the aspects 1, 2, 4, and 5, wherein the light emitting component is configured to emit ultraviolet light.
Aspect 7. The network light device according to any of the aspects 1, 2, 4, 5, and 6, wherein the light emitting component is configured to emit one or more colors in the visible spectrum of the light; and the one or more colors emitted by the light emitting component is determined by the control data received via the network interface.
Aspect 8. The network light device according to any of the aspects 1, 2, 4, 5, 6, and 7, wherein the network interface is configured to connect to a radio frequency for consumer electronic (RF4CE) network.
Aspect 9. A transport unit, comprising the network light device according to any of the aspects 4-8.
Aspect 10. A controller for a network light device, comprising:

a network interface configured to transmit control data to the network light device, and to receive condition data from a sensor;

a processor configured to execute computer-executable instructions for determining whether control data is to be transmitted to the network light device based on the condition data received; and

a power supply configured to supply power to the network interface and the processor.

Aspect 11. The controller according to aspect 10, further comprising:

a non-transitory computer-readable medium configured to store the condition data received by the network interface,

wherein the processor is configured to execute computer-executable instructions for determining whether the control data is to be transmitted to the network light device based on the condition data stored in the non-transitory computer-readable medium.

Aspect 12. The controller according to any of the aspects 10-11, further comprising:

a non-transitory computer-readable medium configured to store a parameter data,

wherein the processor is configured to execute computer-executable instructions for comparing the condition data received by the network interface to the parameter data, and the processor is configured to execute computer-executable instructions for determining whether the control data is to be transmitted to the network light device based on the comparison of the condition data to the parameter data.

Aspect 13. The controller according to any of the aspects 10-12, wherein the network interface is configured to connect to a radio frequency for consumer electronic (RF4CE) network.
Aspect 14. A transport unit, comprising the controller according to any of the aspects 10-13 and/or the network light device according to any of the aspects 1, 2, and 4-8.
Aspect 15. A method for controlling networked light devices arranged in a transportation unit, comprising:

a controller transmitting control data to a network light device;

the network light device receiving the control data; and

the network light device changing operation of the network light device based on the control data received.

Aspect 16. The method according to aspect 15, wherein the changing operation of the network light device includes the network light device emitting a color in the visible spectrum of the light; and the color emitted is determined by the control data.
Aspect 17. The method according to any of the aspects 15-16, wherein the changing operation of the network light device includes the network light device changing wavelength of the light being emitted.
Aspect 18. The method according to any of the aspects 15-17, wherein the changing operation of the network light device includes the network light device emitting ultraviolet light.
Aspect 19. The method according to any of the aspects 15-18, further comprising:

a sensor detecting an environmental condition inside a transportation unit;

the sensor transmitting a condition data based on the environmental condition detected for being received by the controller; and

the controller receiving the condition data,

wherein the controller determines that the control data is to be transmitted to the network light device based on the condition data received.

Aspect 20. The method according to any of the aspects 15-19, wherein the transmitting and the receiving are via a radio frequency for consumer electronic (RF4CE) network.

With regard to the foregoing description, it is to be understood that changes may be made in detail, especially in matters of the construction materials employed and the shape, size and arrangement of the parts without departing from the scope of the present invention. It is intended that the specification and depicted embodiment to be considered exemplary only, with a true scope and spirit of the invention being indicated by the broad meaning of the claims.

What is claimed is:

1. A networked light system for a transportation unit, comprising:
one or more network light devices; and
a controller in communication with the one or more network light devices, the controller being configured to transmit control data for being received by the one or more network light devices, the one or more network light devices being configured to receive the control data and emit light based on the control data received.

2. The networked light system according to claim 1, further comprising:
a sensor configured to detect an environmental condition inside the transportation unit and transmit the environmental condition detected as condition data to the controller, and the controller being in communication with the sensor to receive the condition data and transmit control data to the one or more network light devices that emit light based on the control data received.

3. A transport unit, comprising the network light system according to claim 1.

4. A network light device, comprising:
a network interface configured to receive control data;
a light emitting component configured to emit light based on the control data received via the network interface; and
a power supply configured to supply power to the network interface and the light emitting component.

5. The network light device according to claim 4, wherein the light emitting component is configured to emit one or more wavelengths of the light.

6. The network light device according to claim 4, wherein the light emitting component is configured to emit ultraviolet light.

7. The network light device according to claim 4, wherein the light emitting component is configured to emit one or more colors in the visible spectrum of the light; and the one or more colors emitted by the light emitting component is determined by the control data received via the network interface.

8. The network light device according to claim 4, wherein the network interface is configured to connect to a radio frequency for consumer electronic (RF4CE) network.

9. A transport unit, comprising the network light device according to claim 4.

10. A controller for a network light device, comprising:
a network interface configured to transmit control data to the network light device, and to receive condition data from a sensor;
a processor configured to execute computer-executable instructions for determining whether control data is to be transmitted to the network light device based on the condition data received; and
a power supply configured to supply power to the network interface and the processor.

11. The controller according to claim 10, further comprising:
a non-transitory computer-readable medium configured to store the condition data received by the network interface,
wherein the processor is configured to execute computer-executable instructions for determining whether the control data is to be transmitted to the network light device based on the condition data stored in the non-transitory computer-readable medium.

12. The controller according to claim 10, further comprising:
a non-transitory computer-readable medium configured to store a parameter data,
wherein the processor is configured to execute computer-executable instructions for comparing the condition data received by the network interface to the parameter data, and the processor is configured to execute computer-executable instructions for determining whether the control data is to be transmitted to the network light device based on the comparison of the condition data to the parameter data.

13. The controller according to claim 10, wherein the network interface is configured to connect to a radio frequency for consumer electronic (RF4CE) network.

14. A transport unit, comprising the controller according to claim 10.

15. A method for controlling networked light devices arranged in a transportation unit, comprising:
a controller transmitting control data to a network light device;
the network light device receiving the control data; and
the network light device changing operation of the network light device based on the control data received.

16. The method according to claim 15, wherein the changing operation of the network light device includes the network light device emitting a color in the visible spectrum of the light; and
the color emitted is determined by the control data.

17. The method according to claim 15, wherein the changing operation of the network light device includes the network light device changing wavelength of the light being emitted.

18. The method according to claim 15, wherein the changing operation of the network light device includes the network light device emitting ultraviolet light.

19. The method according to claim 15, further comprising:
a sensor detecting an environmental condition inside a transportation unit;
the sensor transmitting a condition data based on the environmental condition detected for being received by the controller; and
the controller receiving the condition data,
wherein the controller determines that the control data is to be transmitted to the network light device based on the condition data received.

20. The method according to claim 15, wherein the transmitting and the receiving are via a radio frequency for consumer electronic (RF4CE) network.
